(19) United States
(12) Patent Application Publication
(10) Pub. No.: US 2026/0208205 A1
(43) Pub. Date: Jul. 23, 2026

(54) MAGNETIC FILTER ELEMENT AND MAGNETIC FILTERING ASSEMBLY APPARATUS AND METHOD

(71) Applicant: 1773048 ALBERTA LTD., Calgary (CA)

(72) Inventor: ROGER M. SIMONSON, CALGARY (CA)

(21) Appl. No.: 18/727,586

(22) PCT Filed: Jan. 12, 2022
(86) PCT No.: PCT/CA2022/050040

§ 371 Date: Jul. 9, 2024

(51) Int. Cl. B03C 1/28

(52) U.S. Cl. CPC B03C 1/286; B03C 1/284; B03C 2201/18; B03C 2201/22; B03C 2201/28

(57) ABSTRACT

A reusable magnetic device for the extraction of ferrous particles from a body of fluid, wherein the device comprises a plurality of magnets and soft ferrous metal spacers arranged in an alternating sequence to form a stack, the spacers each having a first axial length that is between 12% and 13% greater than a second axial length of each of the magnets, adjacent magnets being arranged with like poles facing, a non-magnetic and non-ferrous end piece terminally disposed at a first end of the stack, and a non-magnetic housing that contains the magnets, the spacers and the end piece. The magnetic device can be installed in a vessel to provide a fluid filtering assembly.

### TECHNICAL FIELD

The invention relates to a magnetic device for extracting ferrous particles from a body of fluid. More particularly, the present invention is directed to a high strength magnetic device that is suitable for use within a housing, conduit or the like through which fluids flow. The invention also relates to an assembly using the magnetic device for the extraction of ferrous particles from a body of fluid.

### BACKGROUND

In industry, it is frequently necessary to remove ferrous particulate contaminants from liquids, such as, for example, lubricating oils, coolant fluids, water, fuels, pump fluids and hydraulic fluids. The use of magnets for this purpose has long been recognized. Attempts have been made to provide a device in which a rod-type magnetic assembly is placed within a cylindrical vessel through which fluid flows, including the devices disclosed in U.S. Pat. No. 4,026,805; 4,176,065; 4,450,075; and 4,883,591. These devices operate on the principle that ferrous particles adhere to the magnetic assembly by magnetic attraction and are thereby isolated from the body of fluid.

The devices indicated above, and other similar devices, however, collectively present a number of drawbacks. For example, they may use low strength magnets, may not offer ease of cleaning, or may be constructed of non-ferrous metal that may allow a dangerous electrical build-up and transfer. In addition, none of the previously disclosed devices are suitable for use with gearbox applications, as they generate a magnetic field around the entire magnetic device including one from the tip resulting in the magnetization of the ferrous gear or shaft and trapping of ferrous contaminants thereon.

Previous assemblies that employ magnetic rods for fluid treatment often include screens, baffles or rings so that there is a resultant restriction to fluid flow. These assemblies require complex bypass systems including pressure release valves. Furthermore, many previous devices result in essentially laminar flow of fluid along the length of the magnetic rod such that filtration of the fluid is inefficient. Finally, some of the previously disclosed devices are designed for specific uses and as such are not adaptable to a variety of systems for which extraction of ferrous particulate contaminants is desired.

### SUMMARY OF INVENTION

In accordance with a broad aspect of the present invention, there is provided a reusable magnetic device for the extraction of ferrous particles from a body of fluid, wherein the device comprises: a plurality of magnets and soft ferrous metal spacers arranged in an alternating sequence to form a stack, the spacers each having a first axial length that is between 12% and 13% greater than a second axial length of each of the magnets, adjacent magnets being arranged with like poles facing, a non-magnetic and non-ferrous end piece terminally disposed at a first end of the stack, and a non-magnetic housing that contains the magnets, the spacers and the end piece, the end piece being selected such that a magnetic field is not present at a terminal tip of the housing adjacent the end piece.

In accordance with another broad aspect of the present invention, there is provided a magnetic filter assembly for the extraction of ferrous particles from a body of fluid, comprising: a magnetic rod including a plurality of magnets and soft ferrous metal spacers arranged in an alternating sequence to form a stack, adjacent magnets being arranged with like poles facing, the spacers each having a first axial length that is between 12% and 13% greater than a second axial length of each of the magnets, a non-magnetic and non-ferrous end piece terminally disposed at a first end of the stack, and a non-magnetic housing that contains the magnets, the spacers and the end piece, the end piece being selected such that a magnetic field is not present at a terminal tip of the housing adjacent the end piece; and a cylindrical vessel within which the magnetic rod is removably mounted, the vessel having fluid inlet adjacent its first end and a fluid outlet adjacent its second end.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

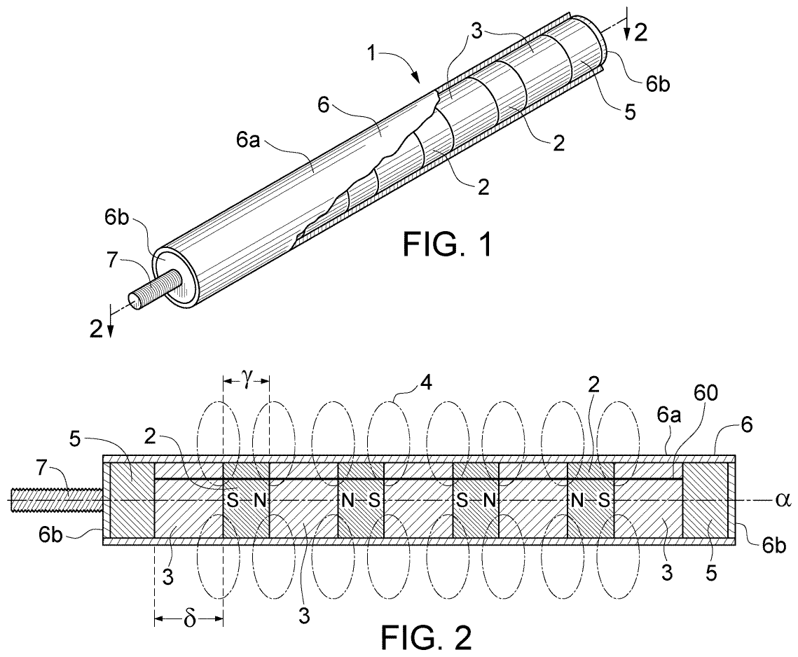

(a) FIG. 1 is a perspective view of a magnetic device according to the present invention with the housing partially cut away to expose the magnets.

(b) FIG. 2 is a sectional view along line 2-2 of FIG. 1.

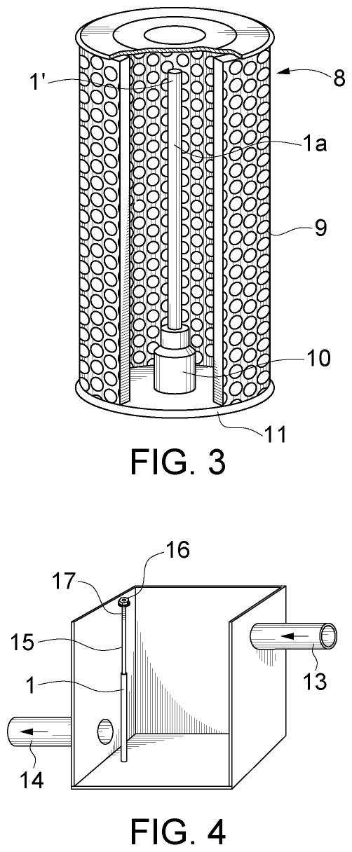

(c) FIG. 3 is a perspective view of a magnetic device according to the present invention wherein the device is in operative position within a fluid filter.

(d) FIG. 4 is a perspective view of a magnetic device according to the present invention wherein the device is in operative position within a fluid reservoir.

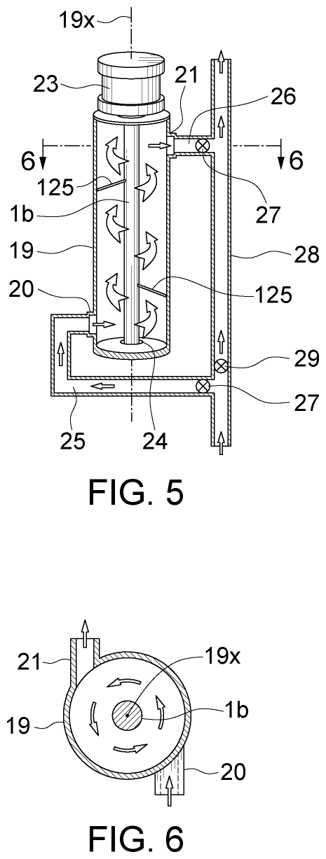

(e) FIG. 5 is a perspective view, partially in section of a magnetic filter assembly according to the present invention.

(f) FIG. 6 is a sectional view along line 6-6 of FIG. 5.

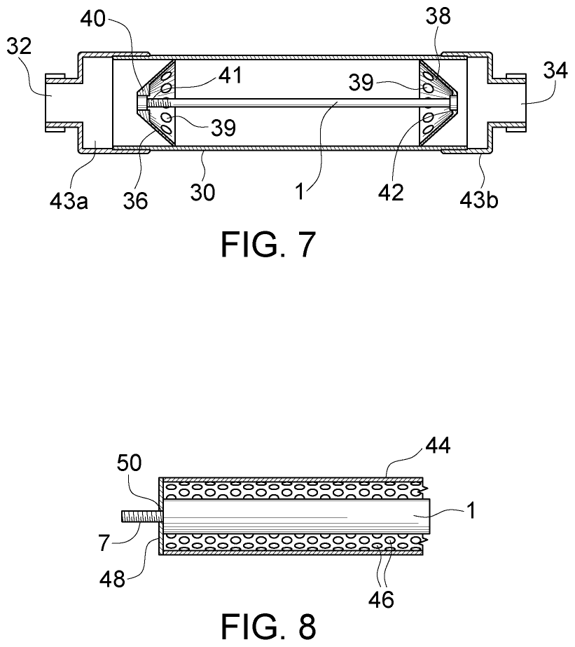

(g) FIG. 7 is a sectional view through another magnetic filter assembly according to the present invention.

(h) FIG. 8 is a perspective view, partially cut away of another magnetic device according to the present invention.

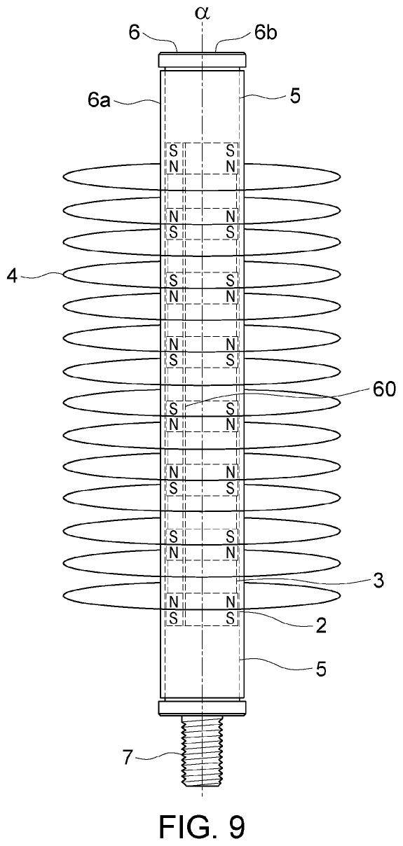

(i) FIG. 9 is an elevation view of a magnetic device according to the present invention with the housing partially cut away to expose the magnets and guide members.

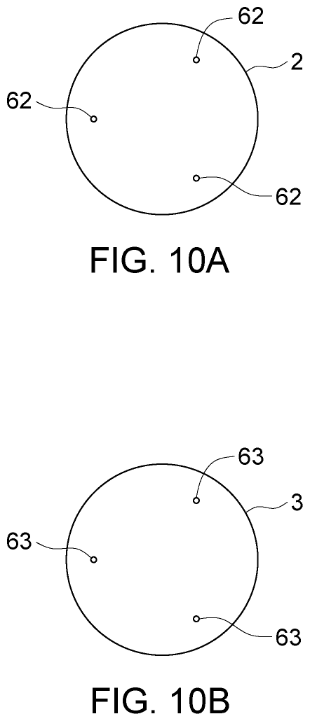

(j) FIG. 10A is a top view of a magnet with guide apertures according to the present invention.

(k) FIG. 10B is a top view of a spacer with guide apertures according to the present invention.

### DETAILED DESCRIPTION OF EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

In industry, new technologies are improving the materials employed in manufacturing processes, and how these materials are manufactured and assembled for rotating equipment and other assemblies. These new methods of manufacturing have and continue to improve the quality of materials of such components, and their tolerances for rotating equipment. A problem arising in the use of high-quality components with relatively narrow tolerance ranges (i.e., narrow tolerable range of space between moving parts under load) is the ability to protect the longevity and integrity of such components while in operation, without the use of lubrication materials.

It is to be understood that high-quality components may include, for example, rare earth magnets comprising minerals of high purity, and/or rare earth magnets made using a manufacturing process managed with quality procedures, which may improve certain characteristics of the magnet, such as increasing its resistance to vibration, maintaining its field strength while in a high-heat environment, which may improve the magnet's effectiveness in the present apparatus.

Lubrication is employed to reduce wear from friction, and reduce the amount of generated heat, to ensure long operational life of the rotating equipment components. To protect these components, often times higher quality lubrication fluids and powders are used, along with improved filtration. Higher quality lubrication fluids and powders may include those produced with higher quality materials or manufacturing processes, such as cast metal parts to machined high grade steel or alloy. The tolerances of critical components under load such as bearings are now under 4000 nm, and at times under 500 nm. In one embodiment, critical components may be coated (e.g., for protection) with a lubricant, for example a 1,000 nm film of lubricant. Accordingly, there is a demand in the market for apparatus and methods directed to filtration of wear contamination under 4000 nm in diameter, for example below 500 nm, to protect the operational integrity and longevity of components that may adversely be affected by exposure to such contamination.

To date, traditional media filtration is generally an ineffective or inefficient means for filtration of hydrocarbon lubrication fluids and dry lubricant powders (e.g., graphite, tungsten, Teflon™, silicone, and molybdenum, to name a few) for wear contamination, such as iron, steel, and silica under 4000 nm in size, and especially for wear contamination particles under 1000 nm in size, for example under 500 nm.

These wear particles under 1000 nm may travel within a film of lubrication material (such as lubrication oil), while lubricating high-tolerance components such as bearings under load, prematurely wearing same.

Currently, magnetic filter elements with very high strength magnetic media fields are the only filtration technology that is capable of cleaning these wear particles (e.g., iron, steel, and silica) from the above-noted media. The holding strength value of the magnetic filter may be selected such that it is maximized to the point that just before the holding strength weight ratio is compromised.

Paramagnetic and fully magnetic metals are transition elements. In their pure form, and/or in compounds with other elements, paramagnetic and fully magnetic metals may react with various materials and applications, for example, chemicals, food products, scientific lab environments, medical and chemical product manufacturing processes, air, and water processes. In industry, it is currently very difficult to remove paramagnetic and magnetic nanoparticles (i.e., particles under 100 nm in diameter) from these materials and applications using traditional paper, fiberglass, polymer and stainless-steel cloth media, as well as magnetic field media on the market today.

Canadian patent 2,331,559 (“'559”) provides a reusable high strength magnetic device for the removal of ferrous particulate contaminants from a body of fluid. The device can be removably installed within the interior of a wide variety of fluid containing systems, such as, for example oil filters, fuel reservoirs, hydraulic pumps, gearboxes, and gas lines. The device is easy to clean and is resistant to corrosion. The magnetic device creates a magnetic field radially about it but does not generate a magnetic field about its long axis, beyond at least one end of the device.

Further, '559 provides a magnetic filter assembly that results in turbulent flow of fluid around the magnetic device such that the fluid is forced to come in full contact with the magnetic field resulting in full filtration of the ferrous contaminants. In one embodiment, the assembly generates a spiral fluid flow path. The spiral flow offers a reasonably long flow path in a compact device. In addition, the assembly has an internal cross-sectional area that tends not to restrict the flow path of the fluid or require bypass systems including pressure release valves.

'559 provides a magnetic filter element assembly that employs high-strength and high-heat-resistant magnets in an assembly with spacers and magnets. The assembly includes soft carbon steel spacers that have substantially the same radial dimensions as the magnets. The spacers are positioned between the magnets, with adjacent magnets being arranged with like poles facing each other (north to north and south to south) along the assembly.

'559 requires the thinnest possible stainless tube housing to house the magnet and spacer assembly, in order to allow the strongest possible magnetic field to project through the housing. For example, in '559, the wall thickness for a small ½ inch diameter magnetic element is 0.02 inches. A thinner wall thickness could result in loss of overall strength integrity; while a thicker wall could result in loss of magnetic field strength and thereby holding strength, as the increased diameter requires thicker walls to maintain strength and maximum field strength. A problem with the need for a thin wall tube is that the structural strength is reduced by the weight of the magnets and spacers, and the length of the assembly.

A second problem is that the magnet and spacer of '559 require a tolerance (for example, measured radial space to the housing, which may be a manufacturer-stated tolerance rating) of 0.035 in (0.889 cm) to permit access for installation of the magnets and spacers in the housing. This space disadvantageously allows the magnets and spacers to shift during assembly, shipping, operation, and maintenance. When the spacers and magnets shift, they become misaligned, which may reduce contact with each adjoining surface, thereby reducing the magnetic field strength of the radial magnetic field, and uniformity of the radial magnetic fields.

Other magnetic filtration apparatus on the market today use low-strength and low-quality magnets that lose their field strength when exposed to high temperature and vibration, reducing their operational lifespan. Low- and high-quality here refer to the type and quality of minerals and manufacturing processes used to make the magnet, which may be rated by holding strength, heat, and vibration resistance to maintain their respective magnetic strengths. Some designs employ inexpensive low-temperature magnets that are not suitable in rotating equipment and other applications with high temperatures, such as temperatures of 500° F. (260° C.) or higher, such as 600° F. (315° C.).

The present disclosure provides improvements over '559 and other magnetic filtration apparatus and methods on the market today. In one embodiment, the apparatus described herein is improved through the use of rare earth magnets with the highest field strength and resistance to vibration and high heat. Furthermore, there are provided apparatus and methods related to magnetic filter elements and housing assemblies that may be capable of high efficiency separation and removal of ferrous and non-ferrous nano-sized solid particles from liquids, solids (such as powders), and/or gases.

For example, the rare earth magnets may include neodymium boron, which may tolerate high heats, such as 275° F. (135° C.) or higher, for example 300° F. (148.9° C.). Rare earth magnets advantageously provide high field strength and resistance to temperature and vibration. In applications with even higher heat applications, such as 550° F. (287.8° C) or higher, for example 600° F. (315.6° C.), a different rare earth mineral, such as samarium cobalt, may be used; however such a magnet was observed in testing to provide 17% lower magnetic field strength compared to an embodiment using neodymium boron. In testing, typical vibration created in rotating equipment applications has not affected holding strength. Holding strength or pull strength of a given magnet element (for example, a disk magnet) may be measured against the face of the disk magnet (for example, 43 lbs (19.5 kg) of pull or holding strength) per magnet in the assembly. The holding strength of the completed magnetic filter element is much higher as a result of the design of the assembly. In testing, the improved design yielded a field holding strength of 416 lbs (188.694 kg), which is 54.07% stronger per linear ft (30.48 cm) of the standard length of 12″ (30.48 cm) and diameter of 1″ (2.54 cm), when compared to an embodiment of '559.

The increased strength improves the ability to separate, from powder, gas, and liquid media, contamination that may be ferrous, paramagnetic, and in some applications, non-magnetic particles under 1000 nm at a higher efficiency than existing magnetic filter element technology. The apparatus may be able to separate non-magnetic particles, for example, through cross contamination of smaller ferrous metals into larger non-ferrous metals during flow in a gas or liquid circuit. While in said flow, the ferrous hard metals may come into abrasive contact with non-ferrous, softer metal during the erosion process. Further or alternatively, during flow of liquids or gas an electromagnetic charge may be created that attaches to the non-ferrous particles and may attract a ferrous charged particle or on its own be pulled out of the flow and captured on the magnetic filter element.

The increased magnetic field holding strength may improve the contamination volume collected by the magnetic element, which may extend the cleaning cycle, reduce the incidence of human contact and injury, and reduce operating costs. This may also advantageously reduce the consumption of lubrication materials, such as hydrocarbon lubrication materials and/or various lubrication fluids. Combustion capability may be improved, reducing emissions.

As discussed further below, the improvements over '559 fall under three categories of changes over '559: first, the length of the spacers; second, the smooth finish of the spacers and/or magnets; and third, the addition of one or more, for example three, guide members that maintain alignment of the spacers and magnets.

Various industries may benefit from these improved apparatus and methods for magnetic filtration, in numerous applications that require separation and removal of nano-sized contaminant particles. Such particles may be fully magnetic or paramagnetic metals, in pure form and as compounds. Transition elements in such particles may include magnesium, sodium, niobium, molybdenum, lithium, technetium, ruthenium, rhodium, palladium, oxygen, thorium, protactinium, uranium, plutonium, cesium, americium, barium, lanthanum, cerium, potassium, praseodymium, calcium, neodymium, scandium, titanium, samarium, vanadium, europium, gadolinium, manganese, terbium, iron, dysprosium, cobalt, holmium, nickel, erbium, thulium, ytterbium, lutetium, hafnium, tantalum, tungsten, rhenium, osmium, rubidium, iridium, strontium, platinum, yttrium, and zirconium. One or more of such materials may have undesirable reactions with various materials and applications, for example, chemicals, food products, scientific labs experiments and environments, medical and chemical product manufacturing processes, and air and water cleaning processes. It is very difficult, and impossible in most applications, to remove magnetic and paramagnetic nanoparticles with traditional filtration media and existing magnetic filtration media.

Hydrocarbon liquid fuels cleaned of metal nanoparticles generally burn with a higher efficiency, resulting in reduced emissions. Methane gas fuel may permit a more efficient burn, with less methane leakage into the atmosphere. Methane is a greenhouse gas emission that can arise from various processes, including those related to drilling wells, transporting natural resources through pipelines, and entry of natural resources into gas plants and refineries where separation of gas and liquids may occur. Each point of contact may give rise to leakage, which may be exacerbated by wear contamination of particles under 1000 nm in size. Unless removed, nanoparticles of iron gives rise to premature wear and damage to seals, valves, compressors and other related equipment from the well head to the end use.

Filtration technology has applications in many industries, including chemical, pharmaceutical, plastics, oil and gas, industrial manufacturing, agriculture, forestry, space, food, and transportation.

Referring to FIGS. 1 and 2 there is illustrated a magnetic device 1 in accordance with an embodiment of the present invention wherein a relatively high magnetic field is obtained by using a stack of strong disc magnets 2 and soft metal disc spacers 3. The stack of magnets and spacers are arranged in alternating positions along the length of the stack with a spacer positioned between each adjacent set of magnets in series. The magnets each are positioned with like poles facing each other through the intervening spacers. Preferably, a spacer is positioned at each end of the stack. The spacers can have approximately the same diameter as the magnets to facilitate stacking. In this arrangement, magnetic fields 4 generated from adjacent like poles confront each other at the middle of the intervening spacer thereby creating longitudinally compressed magnetic fields of increased penetration. The stack may be comprised of any number of magnets and spacers.

While any type of magnet may be used, it is preferred that rare-earth magnets are used to maximize the magnetic force of the assembly. In one embodiment, the rare-earth magnets may be coated with nickel. For most applications, a vibration resistant, high heat, rare-earth magnet is preferred such as, for example, a neodymium boron magnet.

Spacers made of magnetic metal were tested during the research and development of the apparatus and methods described herein. Magnetic metals with high susceptibility of magnetic influence, such as pure iron and nickel, did not yield improved field strength, and delivered a lower holding strength, than soft carbon steel spacers. Accordingly, in a preferred embodiment, the spacers may be made of soft carbon steel.

The spacers may be made of ferrous materials such that the spacer extends the magnetic field surface area and assists in redirecting the fields. Although the spacers may be of a variety of soft ferrous metal constructions, the use of cold rolled material is preferred. Cold rolled material provides low resistance to the magnetic field while also being highly magnetic. In one embodiment, with reference to FIG. 2, each spacer may be have an axial length γ that is between 12 and 13% (for example, 12.5%) longer than a length δ of each magnet. Based on experimental data, these relative lengths were found to yield the strongest magnetic field of the overall assembly, while maintaining the alignment of the components of the assembly. This advantageously avoids and/or mitigates problems of the prior art, in particular the relatively weak magnetic fields of the prior art and the tendency of the magnetic fields of the prior art to deteriorate over time.

Unlike in '559, the spacers and/or magnets may have smooth surfaces, for example, with profile roughness parameters between 11 Ra and 13 Ra, for example 12 Ra. Smooth surfaces allow for a closer contact between the surfaces, which permits more efficient transfer of magnetic fields from the magnets into the spacers, which increases the holding strength. The spacers may be made of carbon steel. The magnets may be nickel-plated. One or more of the spacers and/or magnets may be treated, for example, polished, to provide a smooth surface.

While a cylindrical magnet/spacer shape is preferred for strength and ease of handling, it will be appreciated that shape of the spacers and magnets may vary from that described here. The use of components of solid construction, however, provides for the greatest field strength.

To substantially reduce the magnetic fields at an end of the device, a non-ferrous end-piece is attached at one end of the stack. In this manner, the device may be easily cleaned of adhering particles by simply wiping any particles magnetically attached thereto to the end of the device from which they will fall off. The end-piece can be of a variety of materials including wood, copper and plastic. Preferably, the end piece is shaped similarly to the magnets to facilitate assembly. If it is desirable that both ends be without magnetic field, an end-piece can be placed at both ends of the stack, as shown.

It is to be appreciated that the device may be used in combination with other cleaning apparatus and methods, such as those described in international patent application publication WO2021/026659 A1, and related properties.

The stack of magnets 2, spacers 3 and end-piece 5 are contained within a housing 6. Housing 6 is formed of a non-magnetic material resistant to damage from the environment in which the magnetic device is to be used. A particularly useful material for forming the housing is stainless steel since it is resistant to both corrosion and impact damage in many environments. In addition, the strength of stainless steel may allow the housing to be very thin-walled, which may thereby reduce interference with the magnetic fields.

Housing 6 in the illustrated embodiment includes a sidewall 6a and a pair of end plugs 6b. The sidewall is formed of, for example, stainless steel tubing and the end plugs are welded into place. End plugs 6b can also be secured by other means such as adhesives or snap rings. Of course, the housing can be constructed of other materials such as plastics, as previously noted.

Housing 6 can be any shape and size. Preferably, housing 6 closely surrounds the magnets. It has been found that a cylindrical form is most useful as it works best with fluid flow there past.

To reduce damage both to the housing and to the magnets by vibration, preferably the magnets 2, spacers 3 and end pieces 5 are secured together by adhesive. For standard magnetic filter elements, an adhesive, such as a non-setting silicone sealant, may be applied between one or more of the internal parts 2, 3 and 5 and housing 6 to reduce vibration and thereby protect the assembly's magnetic fields. This may be particularly advantageous for heavy duty applications with pressures over 1000 PSI in the environment in which the magnetic filter element is employed.

With reference to FIGS. 2 and 9, the device may include one or more elongate guide members 60 for maintaining alignment of the spacers and magnets. With reference to FIGS. 10A and 10B, each spacer 3 may have a guide aperture 63 that extends from a first planer side of the spacer to an opposite planer side. Each guide aperture 63 is for accepting one of the guide members. Similarly, each magnet 2 may have a guide aperture 62 for each of the guide members. In the illustrated embodiments of FIGS. 10A and 10B, three apertures are shown, which would accommodate up to three guide members. The magnets and spacers may be arranged such that their apertures are axially aligned, allowing each of the guide members to extend along (e.g., through) the stack of magnets and spacers when assembled.

In assembly, the guide members may extend through the guide apertures in each of the spacers and magnets. In other words, the spacers and magnets are threaded onto the guide members. The guide members may extend substantially parallel to a long axis α of the assembly. The guide members may extend substantially parallel to one another. The guide members may be positioned radially between axis α and an inner wall of housing 6. The guide members may advantageously maintain the dimensional integrity of the assembly in general, and the alignment of the magnets and spacers in particular. This may ensure that the magnetic radial fields are consistent (e.g., substantially equal) around the circumference of the assembly tube. The guide members may also improve the structural strength of the assembly.

The guide apertures of the magnets may be similarly spaced apart and positioned so that they can be aligned with the guide apertures of the spacers. While one guide member and associated guide apertures may provide some benefit, a plurality of guide members and associated guide apertures provides the additional benefit that the guide members cannot rotate relative to one another, thereby enhancing the alignment of the components of the assembly. Each guide aperture may be concentric with another guide aperture of an adjacent magnet or spacer. Each guide aperture may be axially aligned with another guide aperture of an adjacent magnet or spacer.

The guide members may be rigid. The guide members may be made of stainless steel. The guide members may be flat wires or have a construction similar to that of flat wires. The guide members may be substantially rectangular in cross section. Such an arrangement, in contrast to, for example, cylindrical wires, may improve rigidity and allow for a greater surface area for contact on the magnet, spacer and guide aperture. The guide apertures may be shaped to receive the guide members, i.e., the guide apertures may also be substantially rectangular.

As the device may be used within a fluid containing apparatus, attachment means for securing the device to such an apparatus is provided. The attachment means may vary depending on the application, and can include, for example, a threaded rod 7 for engagement into a threaded aperture or fastener or a magnet for magnetic attachment to apparatus constructed of ferrous materials. In any case, the attachment means is firmly attached to one end of the magnetic device, such as, for example, by welding, or adhesive attachment to housing 6.

FIGS. 3 and 4 exemplify the use of the magnetic device within different types of fluid containing apparatus. FIG. 3 shows a magnetic device la according to the present invention within the core of a fluid filter 8, such as an oil filter. In this case, device la includes a magnetic base 10, including a strong magnet secured within a cavity, attached at one end of the housing to secure the device by magnetic attraction to the metal bottom 11 of the filter. In this example, fluid flows into the core of the filter from the top of the filter and out through the barrier filtration media 9. To maximize the efficiency of the magnetic filtration, the magnetic device is centrally located within the core. Because the magnetic filter removes ferrous contaminants before they encounter the barrier filter, the barrier filter does not become clogged with such contaminants and therefore the usefulness of the barrier filter is increased. Furthermore, while the barrier filter may not retain particles below a certain size, the magnetic filtration is not size-dependent. The overall efficiency of the filtration system is therefore greatly improved with use of the magnetic filter.

Having a magnetic attachment to the filter, magnetic device la can be removed, cleaned and installed in another or same filter. Wiping accumulated debris to end 1′ opposite magnetic base 10 cleans the device. End 1′, having a copper end-piece therein, does not have a magnetic field associated therewith. At end l′ any debris can be wiped off easily without having to overcome magnetic attractive forces.

FIG. 4 demonstrates the placement of a magnetic device 1 according to the present invention within a fluid reservoir 13. In this case, device 1 is placed directly in front of the fluid outlet 14 of the reservoir so as to magnetically attract particles flowing past the device and into outlet 14. The device is secured, by threaded connection, to an elongate rod 15. The rod can be any desired length suitable to position device 1 in a selected location within a reservoir. Rod 15 and device 1 are inserted through a port in the reservoir wall. A bolt 16 is attached to a threaded portion 17 on the rod to secure the rod and the device within the reservoir. Of course, to avoid the use of an extension rod, magnetic device 1 could have been elongated. However, this would increase cost.

Referring to FIGS. 5 and 6 there is illustrated a magnetic filtering assembly. The assembly includes a cylindrical vessel 19 in which a magnetic rod 1b, such as that described above, is positioned. The vessel can be formed of any material resistant to damage by the fluids to be passed therethrough. Common materials are aluminum, stainless steel and plastics. The vessel has an inlet 20 and an outlet 21 connected to sidewall portions of the vessel and positioned to be offset from the central axis 19x of the vessel. The inlet is positioned near the bottom of the vessel and the outlet is positioned near the top of the vessel. Fluid enters the vessel though the inlet and is deflected by the vessel sidewall and the magnetic rod to flow in a spiral fashion through the vessel. As the fluid travels upwards through the vessel towards the outlet, it continues to flow in a spiral around the rod until it leaves the vessel through the outlet. This circular flow of the fluid around the rod creates turbulence in the fluid flow and effectively increases the path length by which fluid is required to travel through the vessel and past the rod as compared to previous filtering assemblies wherein laminar flow of fluid was common. Consequently, the efficiency of the magnetic filtration is increased.

The filter housing may be constructed to ensure maximum magnetic field strength exposure to given the medium or media that will flow therethrough in application. One or more flow diverters 125 (as shown in FIG. 5) may be provided between an inner wall of vessel 19 and an outer wall of the rod 1b. The flow diverters disrupt laminar flow and promote turbulence, allowing the flow to have maximum exposure to the magnetic field media.

The flow diverters may be used for affecting flow path of the fluid within the vessel 19. The flow diverters may cause fluid to be redirected (in other words, diverted) along a tortuous path, which may promote contact with the rod so that more ferrous material may be collected. Each flow diverter is a structure within the vessel that causes fluid flow to be directed around the flow diverter. Each flow diverter may be a substantially planar member. Each flow diverter may have a pie shape (in other words, a sector shape) with edges extending from the rod to the vessel. Accordingly, each flow diverter may have a third edge proximate the vessel, which may have an arc shape. A first flow diverter and a second flow diverter may be oriented at different radial and/or axial positions with respect to the rod, in order to promote turbulence within the vessel.

Preferably, rod 1b is positioned generally concentrically within the vessel. To provide for easy removal and replacement of the rod for cleaning, the rod is secured to a removable cap 23. The cap can be secured to the vessel by threaded engagement or other means such as quick couplers. To remove the rod, the cap is removed and the rod being attached to the cap is removed with the cap. The rod is stabilized within the vessel by insertion into an indentation 24 in the lower end of the vessel.

In use, vessel 19 is connected into a fluid flow conduit between a supply pipe 25 and an exit pipe 26. To permit removal or opening of the vessel, valves 27 are provided in the supply pipe and the exit pipe to shut off the flow of fluid. To provide for taking the vessel off line while the fluid continues to flow through the fluid flow conduit, preferably a bypass pipe 28 is installed between supply pipe 25 and exit pipe 26. Valve 29 controls the flow of fluid through bypass pipe 28.

Inlet 20 is selected to have a cross-sectional area about equal to or greater than the cross-sectional area of the supply pipe connected to the inlet, such that there is no restriction to fluid flow into the vessel. In addition, there is no restriction to flow through the vessel. Preferably, outlet 21 has a cross-sectional area about equal to or greater than the cross section area of the inlet.

Another magnetic filtering assembly according to the present invention is shown in FIG. 7. The assembly includes a vessel 30 and a magnetic rod 1 similar to that described in FIG. 1. The vessel includes an inlet 32 at its first end and an outlet 34 at its opposite end. Each of the inlet and outlet include a quick coupler for easy connection into a fluid flow conduit. A first baffle 36 is mounted within the vessel adjacent the inlet and a second baffle 38 is connected adjacent the outlet. Baffles 36, 38 are generally conical including apertures 39 formed therethrough. Baffles 36, 38 tend to create turbulence in fluid flowing there past and increases the amount of fluid passing through the strong magnetic field generated close to rod 1. The total open area of the apertures on each baffle are about equal to or greater than the cross-sectional area of the inlet, such that no resistance to flow is created by passing through the baffle.

Baffle 36 includes a central threaded aperture 40 though which rod 1 is passed and engaged by threaded portion 41 on an end of the rod. Rod 1 is stabilized by insertion into an indentation 42 at the center of baffle 38.

To access rod 1 for cleaning, vessel may include a threaded cap 43a at one end. To facilitate assembly, a cap 43b can form the opposite end of the vessel and be secured by welding, threaded engagement or other means. Magnetic filtering assemblies according to the present invention can be installed in-line for a variety of applications.

With reference to FIG. 8, because of the strong magnets in a device 1 according to the present invention, the device can sometimes be magnetically attracted to various parts of a ferrous tank in which it is positioned. This can inhibit placement to, and removal of, the device from the tank. Therefore, in one embodiment, a spacing sleeve 44 may be positioned around the device. The sleeve may have large openings 46 to permit flow of fluid therethrough and into contact with device 1. However, sleeve 44 may be formed of a rigid, non-magnetic material such as plastic or stainless steel and may maintain spacing between surrounding surfaces and the device so that strong magnetic attraction therebetween cannot be established. Sleeve 44 can be secured to the rod in any desired way. In the illustrated embodiment, sleeve 44 includes an end wall 48 with a centrally located aperture 50 therethrough. Aperture 50 is inserted over threaded rod 7 prior to installation of the device in a fluid container.

### Clauses

Clause 1. A reusable magnetic device for the extraction of ferrous particles from a body of fluid, wherein the device comprises: a plurality of magnets and soft ferrous metal spacers arranged in an alternating sequence to form a stack, the spacers each having a first axial length that is between 12% and 13% greater than a second axial length of each of the magnets, adjacent magnets being arranged with like poles facing, a non-magnetic and non-ferrous end piece terminally disposed at a first end of the stack, and a non-magnetic housing that contains the magnets, the spacers and the end piece, the end piece being selected such that a magnetic field is not present at a terminal tip of the housing adjacent the end piece.

Clause 2. The reusable magnetic device as in any one or more of the clauses, wherein each of the magnets and spacers has a smooth surface.

Clause 3. The reusable magnetic device as in any one or more of the clauses, wherein each of the magnets and spacers is polished.

Clause 4. The reusable magnetic device as in any one or more of the clauses, wherein each of the magnets is coated with nickel.

Clause 5. The reusable magnetic device as in any one or more of the clauses, wherein two or more of the spacers, magnets, and end piece, and housing are secured together by a non-setting silicone sealant.

Clause 6. The reusable magnetic device as in any one or more of the clauses, further comprising: a guide aperture in each of the magnets and spacers; and an elongate guide member installed in the guide apertures.

Clause 7. The reusable magnetic device as in any one or more of the clauses, further comprising: a second guide aperture in each of the magnets and spacers; and a second elongate guide member installed in the second guide apertures.

Clause 8. The reusable magnetic device as in any one or more of the clauses, wherein: the elongate guide member is substantially rectangular in cross section.

Clause 9. The reusable magnetic device as in any one or more of the clauses, further comprising: an attachment means connected to the housing for removably installing the device within a body of fluid.

Clause 10. The reusable magnetic device as in any one or more of the clauses, further comprising: a spacing sleeve disposed about the housing and having openings therethrough.

Clause 11. A magnetic filter assembly for the extraction of ferrous particles from a body of fluid, comprising: a magnetic rod including a plurality of magnets and soft ferrous metal spacers arranged in an alternating sequence to form a stack, adjacent magnets being arranged with like poles facing, the spacers each having a first axial length that is between 12% and 13% greater than a second axial length of each of the magnets, a non-magnetic and non-ferrous end piece terminally disposed at a first end of the stack, and a non-magnetic housing that contains the magnets, the spacers and the end piece, the end piece being selected such that a magnetic field is not present at a terminal tip of the housing adjacent the end piece; and a cylindrical vessel within which the magnetic rod is removably mounted, the vessel having fluid inlet adjacent its first end and a fluid outlet adjacent its second end.

Clause 12. The magnetic filter assembly as in any one or more of the clauses, wherein each of the magnets and spacers has a smooth surface.

Clause 13. The reusable magnetic device as in any one or more of the clauses, wherein each of the magnets and spacers is polished.

Clause 14. The magnetic filter assembly as in any one or more of the clauses, further comprising: a guide aperture, in each of the magnets and spacers; and an elongate guide member installed in the guide apertures.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A reusable magnetic device for the extraction of ferrous particles from a body of fluid, wherein the device comprises:
a plurality of magnets and soft ferrous metal spacers arranged in an alternating sequence to form a stack, the spacers each having a first axial length that is between 12% and 13% greater than a second axial length of each of the magnets,
adjacent magnets being arranged with like poles facing,
a non-magnetic and non-ferrous end piece terminally disposed at a first end of the stack, and
a non-magnetic housing that contains the magnets, the spacers and the end piece, the end piece being selected such that a magnetic field is not present at a terminal tip of the housing adjacent the end piece.

2. The reusable magnetic device as in claim 1, wherein each of the magnets and spacers has a smooth surface.

3. The reusable magnetic device as in claim 2, wherein each of the magnets and spacers is polished.

4. The reusable magnetic device as in claim 1, wherein each of the magnets is coated with nickel.

5. The reusable magnetic device as in claim 1, wherein two or more of the spacers, magnets, and end piece, and housing are secured together by a non-setting silicone sealant.

6. The reusable magnetic device as in claim 1, further comprising:
a guide aperture in each of the magnets and spacers; and
an elongate guide member installed in the guide apertures.

7. The reusable magnetic device as in claim 6, further comprising:
a second guide aperture in each of the magnets and spacers; and
a second elongate guide member installed in the second guide apertures.

8. The reusable magnetic device as in claim 6, wherein:
the elongate guide member is substantially rectangular in cross section.

9. The reusable magnetic device as in claim 1, further comprising: an attachment means connected to the housing for removably installing the device within a body of fluid.

10. The reusable magnetic device as in claim 1, further comprising: a spacing sleeve disposed about the housing and having openings therethrough.

11. A magnetic filter assembly for the extraction of ferrous particles from a body of fluid, comprising:
a magnetic rod including a plurality of magnets and soft ferrous metal spacers arranged in an alternating sequence to form a stack, adjacent magnets being arranged with like poles facing, the spacers each having a first axial length that is between 12% and 13% greater than a second axial length of each of the magnets,
a non-magnetic and non-ferrous end piece terminally disposed at a first end of the stack, and
a non-magnetic housing that contains the magnets, the spacers and the end piece, the end piece being selected such that a magnetic field is not present at a terminal tip of the housing adjacent the end piece; and
a cylindrical vessel within which the magnetic rod is removably mounted, the vessel having fluid inlet adjacent its first end and a fluid outlet adjacent its second end.

12. The magnetic filter assembly as in claim 11, wherein each of the magnets and spacers has a smooth surface.

13. The reusable magnetic device as in claim 12, wherein each of the magnets and spacers is polished.

14. The magnetic filter assembly as in claim 11, further comprising:
a guide aperture, in each of the magnets and spacers; and
an elongate guide member installed in the guide apertures.
